(19) United States
(12) Patent Application Publication
(10) Pub. No.: US 2024/0370605 A1
(43) Pub. Date: Nov. 7, 2024

(54) SIMULATOR

(71) Applicant: TOYOTA JIDOSHA KABUSHIKI KAISHA, Aichi-ken (JP)

(72) Inventors: Yusuke ONDA, Edogawa-ku (JP); Hiroshi OKI, Seto-shi (JP); Norihito NAKATA, Kobe-shi (JP)

(21) Appl. No.: 18/646,762

(22) Filed: Apr. 26, 2024

(30) Foreign Application Priority Data
May 1, 2023 (JP) 2023-075624

(51) Int. Cl. G06F 30/20; G06F 111/10; G06F 113/04; G06F 119/02

(52) U.S. Cl. CPC G06F 30/20; G06F 2113/04; G06F 2119/02

(57) ABSTRACT

A simulator capable of communicating with an energy management system (EMS), the simulator including a simulator unit configured to execute a simulation of an algorithm program to be evaluated for the EMS, a performance determination unit configured to determine performance of the algorithm program to be evaluated based on a result of operations of the simulator unit, and a quality determination unit for the simulation unit, wherein an interface for when the algorithm program to be evaluated is incorporated into the simulator and an interface for when the algorithm program to be evaluated is incorporated into the EMS are commonalized.

### CROSS-REFERENCE TO RELATED APPLICATION

This application claims priority to Japanese Patent Application No. 2023-075624, filed on May 1, 2023, the entire contents of which are incorporated herein by reference.

### TECHNICAL FIELD

The present disclosure relates to a simulator.

### BACKGROUND

A power grid simulation system that includes power grid operation scenarios describing events that occur in the power grid, a power grid model for simulating the electrical characteristics of the main circuit, an auxiliary equipment H/W model for simulating the electrical characteristics of the auxiliary equipment, and an auxiliary equipment S/W model for simulating the operation algorithm of the auxiliary equipment is known. For example, see Patent Literature (PTL) 1. These scenarios and models are converted into components and stored in a library, and an object to be simulated is constructed by combining any of the components.

### CITATION LIST

### Patent Literature

PTL 1: JP 2001-268791 A

### SUMMARY

In the above background technology, the simulator is not connected to the EMS because the development of the EMS is conducted individually by each manufacturer and closed within each manufacturer. For this reason, completed algorithms cannot be incorporated directly into the Energy Management System (EMS).

It would be helpful to enable a developed program to be incorporated into an EMS and executed without modification.

A simulator according to an embodiment of the present disclosure is a simulator capable of communicating with an energy management system (EMS), the simulator including:
a simulator unit configured to execute a simulation of an algorithm program to be evaluated for the EMS;
a performance determination unit configured to determine performance of the algorithm program to be evaluated based on a result of operations of the simulator unit; and
a quality determination unit for the simulation unit,
wherein an interface for when the algorithm program to be evaluated is incorporated into the simulator and an interface for when the algorithm program to be evaluated is incorporated into the EMS are commonalized.

According to an embodiment of the present disclosure, a developed program can be incorporated into an EMS and executed without modification.

### BRIEF DESCRIPTION OF THE DRAWINGS

In the accompanying drawings:

FIG. 1 is a schematic diagram of an information processing system; and

FIG. 2 is a block diagram illustrating a configuration of a simulator unit.

### DETAILED DESCRIPTION

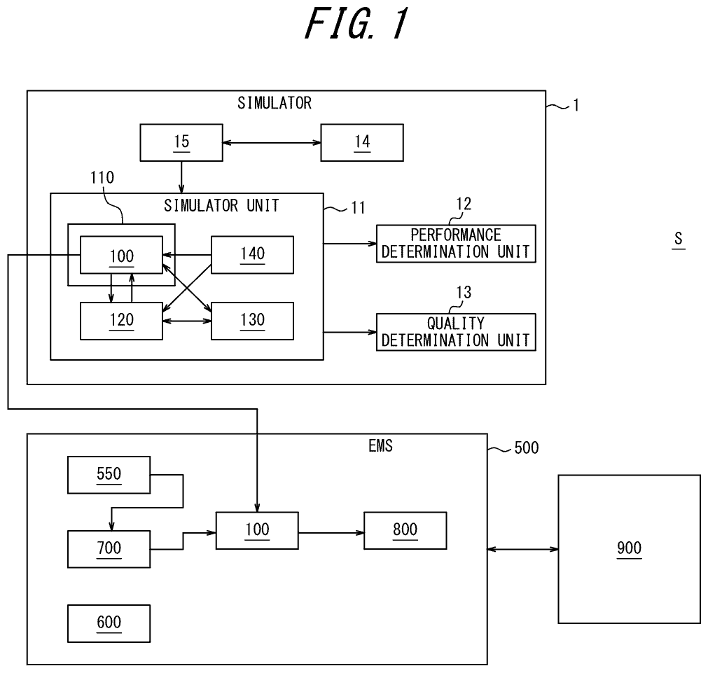

FIG. 1 is a schematic diagram of an information processing system S according to the present embodiment. The information processing system S includes a simulator 1, an EMS 500 (Energy Management System 500), and a device group 900 that can communicate with each other via a network. The network includes, for example, a mobile communication network, a fixed communication network, or the Internet.

FIG. 1 illustrates one of the simulator 1 for convenience of explanation. However, the number of simulators 1 is not limited to this. For example, processing to be executed by the simulator 1 according to the present embodiment may be executed by a plurality of distributed simulators 1.

The simulator 1 is installed in a facility such as a data center or charging station. The simulator 1 is a computer such as a server that belongs to a cloud computing system or other computing system.

In FIG. 1, an internal configuration of the simulator 1 will be described in detail.

The simulator 1 includes a simulator unit 11, a performance determination unit 12, a quality determination unit 13, a user interface 14, and a simulator execution program 15. Each component of the simulator 1 is communicably connected to each other.

The simulator 1 includes a controller, a communication interface, and a memory. The simulator unit 11, the performance determination unit 12, the quality determination unit 13, and the simulator execution program 15 may be functions executed by controller using information stored in the memory.

The controller includes, for example, one or more general purpose processors including a Central Processing Unit (CPU) or a Micro Processing Unit (MPU). The controller may include one or more dedicated processors that are dedicated to specific processing. The controller may include one or more dedicated circuits instead of the processor. Examples of the dedicated circuits may include a Field-Programmable Gate Array (FPGA) and an Application Specific Integrated Circuit (ASIC). The controller may include an Electronic Control Unit (ECU). The controller transmits and receives any information via the communication interface.

The communication interface includes, for connecting to the network NW, one or more communication modules that conform to wired or wireless Local Area Network (LAN) standards. The communication interface may include a module conforming to one or more mobile communication standards including the Long Term Evolution (LTE) standard, the 4th Generation (4G) standard, or the 5th Generation (5G) standard. The communication interface may include one or more communication modules conforming to near field communication standards or specifications, including Bluetooth (Bluetooth is a registered trademark in Japan, other countries, or both), AirDrop (AirDrop is a registered trademark in Japan, other countries, or both), IrDA, ZigBee (ZigBee is a registered trademark in Japan, other countries, or both), Felica (Felica is a registered trademark in Japan, other countries, or both), or RFID. The communication interface transmits and receives any information via the network NW.

The memory includes, for example, a semiconductor memory, a magnetic memory, an optical memory, or a combination of at least two of these, but is not limited to these. The semiconductor memory is, for example, RAM or ROM. The RAM is, for example, SRAM or DRAM. The ROM is, for example, EEPROM. The memory may function, for example, as a main memory, an auxiliary memory, or a cache memory. The memory may store information resulting from analysis or processing performed by the controller. The memory may store various types of information regarding operations or control of the simulator 1. The memory may store a system program, an application program, embedded software, and the like. The memory may be provided outside the simulator 1 and accessed by the simulator 1.

The user interface 14 of the simulator 1 includes at least one display, one input interface and one output interface.

The display is, for example, a display. The display is, for example, an LCD or an organic EL display. The term “LCD” is an abbreviation of liquid crystal display. The term “EL” is an abbreviation of electro luminescence. The display, instead of being included in the simulator 1, may be connected to the simulator 1 as an external output device. As a connection method, any technology such as USB, HDMI® (HDMI is a registered trademark in Japan, other countries, or both), or Bluetooth® can be used. The term “USB” is an abbreviation of Universal Serial Bus. The term “HDMI®” is an abbreviation of High-Definition Multimedia Interface. The display may be a touch panel.

The input interface is, for example, a microphone, a physical key, a capacitive key, a pointing device, or a touch screen integrally provided with a display. The input interface accepts an operation for inputting information to be used for the operations of the simulator 1. The input interface may be connected to the simulator 1 as an external input device, instead of being provided in the simulator 1. As a connection method, any technology such as USB, HDMI® (HDMI is a registered trademark in Japan, other countries, or both), or Bluetooth® can be used.

The output interface includes at least one output interface for outputting information to notify a user of the information. For example, the output interface included in the output interface is a speaker for outputting the information in the form of audio, or the like, but is not limited to this.

The simulator unit 11 executes the simulation of the algorithm program to be evaluated for the EMS 500. For example, the algorithm program to be evaluated may be an algorithm developed by an engineer. The developed algorithm program to be evaluated is mounted on the simulator unit 11 by means of a user interface 14 or other means.

The simulator unit 11 includes a reproduction program 110 that reproduces the object to be evaluated by the EMS 500, a simulation program 120 for a device to be controlled by the EMS 500, a database 140 for input that stores input data to be input for running the simulation, and a database 130 for storage that stores the results of the simulation. The algorithm program 100 to be evaluated is incorporated into the reproduction program 110. The simulator unit 11 operates the reproduction program 110 and the simulation program 120 using the input data stored in the database 140 for input, and stores the operation result in the database 130 for storage.

The performance determination unit 12 determines the performance of the algorithm program to be evaluated from the result of operations of the simulator unit 11. The performance determination unit 12 determines whether the performance of the algorithm program to be evaluated can withstand actual operation. For example, the performance determination unit 12 determines the prediction accuracy or control accuracy of the algorithm program to be evaluated. Any performance determination method may be employed.

The quality determination unit 13 determines whether the simulator unit 11 has operated correctly. For example, the quality determination unit 13 determines whether the minimum requirements are met, such as whether the positive (charge) and negative (discharge) settings are incorrect. Any quality determination method may be employed.

The interface for when the algorithm program 100 to be evaluated is incorporated into the simulator 1 (e.g., the reproduction program 110) and the interface for when the algorithm program 100 to be evaluated is incorporated into the EMS 500 are commonalized. The interfaces that are commonalized may be, for example, at least one of the following: definitions, communication standards, programming languages (e.g., Python, C++), functions, Application Programming Interfaces (APIs).

The EMS 500 may be any energy management system. The EMS 500 includes the following components:
an algorithm program 100 to be evaluated;
a database 550;
a function 700 to collect information on device operation;
a customer management system 600; and
a function 800 to transmit of the operation command point of each device.

The device group 900 includes devices actually installed in a town or other location. The device group 900 includes, for example, at least one of the following: a building air conditioning unit, a FC generator, a stationary storage battery, a battery electric vehicle (BEV) charger, and a solar generator.

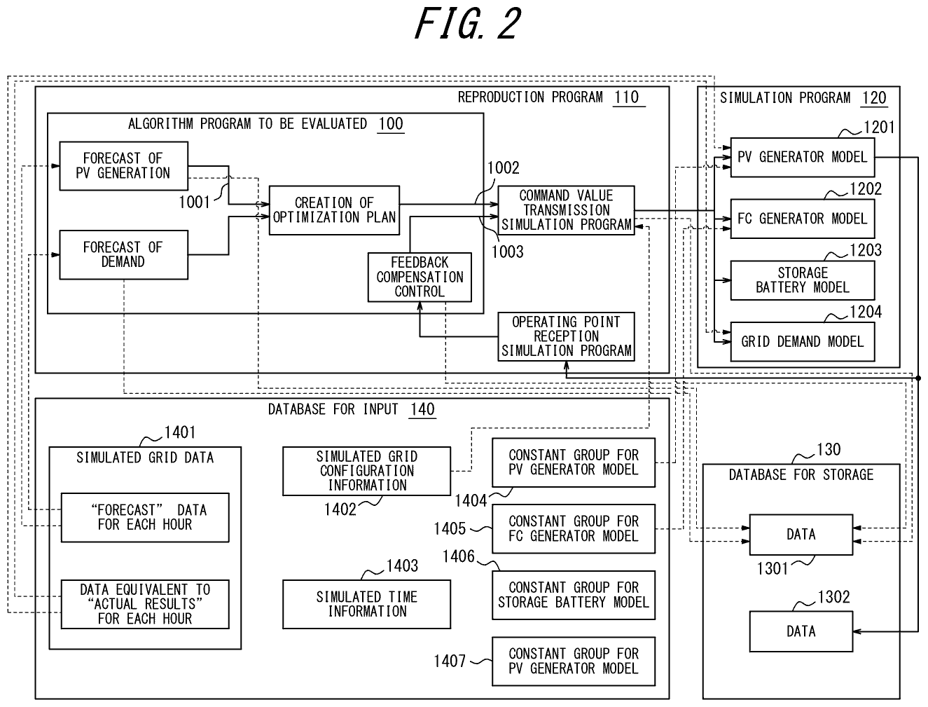

In FIG. 2, the information processing method by the simulator unit 11 is described in detail.

The following information is stored in the database 140 for input:
forecast data for each hour as simulated grid data 1401 (e.g., weather forecast as of 12:00 p.m. on January 1 until January 3);
data equivalent to the actual results for each hour as the simulated grid data 1401 (e.g., actual solar radiation data as of 12:00 on January 1, actual electricity demand data as of 12:00 on January 1);
simulated grid configuration information 1402 (e.g., number of photovoltaic (PV) generators, number of fuel cell (FC) generators, number of batteries, grid connection information, etc.);
simulated time information 1403 (actual CEMS is controlled in real time, but in the case of simulation, each program is executed assuming a specific date and time);
   a constant group 1404 for a PV generator model (e.g., rated output, conversion efficiency, etc.);
   a constant group 1405 for an FC generator model (e.g., rated output, conversion efficiency, etc.);
a constant group 1406 for a storage battery model (e.g., rated output, rated battery capacity, conversion efficiency, etc.); and
a constant group 1407 for a grid demand model (e.g., grid power capacity, device configuration, etc.).

The reproduction program 110 uses the simulated grid data 1401 to forecast PV generation and demand and outputs forecast results 1001, and creates an optimization plan 1002 (e.g., charge/discharge plan, power purchase plan) for the operation of each device from the forecast results 1001. The reproduction program 110 sends the optimization plan 1002 to the command value transmission simulation program, which also uses the simulated grid configuration information 1402 to generate operating command values. The reproduction program 110 sends the operation command values to the simulation program 120.

The simulation program 120 operates a PV generator model 1201, an FC generator model 1202, a storage battery model 1203, and a grid demand model 1204 using the operation command values, the simulated grid data 1401, the constant group 1404 for the PV generator model, the constant group 1405 for the FC generator model, the constant group 1406 for the storage battery model, and the constant group 1407 for the grid demand model, and outputs data equivalent to actual results that simulate the actual operation behavior of the device group 900. The output data is stored in the database 130 for storage. Some of the output data is fed back to the reproduction program 110 to be compensated and controlled, and passed to the command value transmission simulation program as the command values 1003.

The forecast results or optimization plan created by the reproduction program 110 and the operation command values for each device are stored in the database 130 for storage.

As described above, according to the present embodiment, the simulator 1 includes a simulator unit 11 that executes a simulation of an algorithm program to be evaluated for the EMS 500, a performance determination unit 12 that determines performance of the algorithm program to be evaluated based on a result of operations of the simulator unit 11, and a quality determination unit 13 for the simulator unit 11. An interface for when the algorithm program to be evaluated is incorporated into the simulator 1 and an interface for when the algorithm program to be evaluated is incorporated into the EMS 500 are commonalized. This configuration allows the developed algorithm program to be evaluated to be incorporated directly into the EMS 500 without modification and executed to control actual devices. Furthermore, even if the algorithm program to be evaluated or the devices are updated daily, the development lead time to respond to the updates can be reduced.

According to the present embodiment, the simulator unit 11 includes a reproduction program 110 that reproduces an object to be evaluated by the EMS 500, a simulation program 120 for a device to be controlled by the EMS 500, and a database 140 for input that stores input data to be input for executing the simulation. The simulator unit 11 causes the reproduction program 110 and the simulation program 120 to operate using the input data and stores an operation result. This configuration allows the simulator 1 to simulate the control of actual devices.

According to the present embodiment, the performance determination unit 12 also determines the prediction accuracy or control accuracy of the algorithm program to be evaluated. This configuration allows the simulator 1 to further improve the accuracy of the algorithm program to be evaluated.

According to the present embodiment, the interfaces that are commonalized include communication standards, programming languages, functions, and/or APIs. This configuration allows the developed program to be incorporated directly into the EMS 500 and executed without modification in various cases.

According to the present embodiment, the performance determination unit 12 determines whether the performance of the algorithm program to be evaluated can withstand actual operation, and the quality determination unit 13 determines whether the simulator unit 11 has operated correctly. This configuration allows the simulator 1 to confirm that the algorithm program to be evaluated is operating correctly and that the performance of the algorithm program to be evaluated can withstand actual operation.

While the present disclosure has been described with reference to the drawings and examples, it should be noted that various modifications and revisions may be implemented by those skilled in the art based on the present disclosure. Other modifications can be made without departing from the spirit of the present disclosure. For example, functions or the like included in each means or each step can be rearranged without logical inconsistency, and a plurality of means or steps can be combined into one or divided.

For example, in the above embodiment, a program that executes all or some of the functions or processing of the simulator 1 may be recorded on a computer readable recording medium. The computer readable recording medium includes a non-transitory computer readable medium and is, for example, a magnetic recording apparatus, an optical disc, a magneto-optical recording medium, or a semiconductor memory. The distribution of the program is performed by, for example, sale, transfer, or rental of a portable recording medium such as a Digital Versatile Disc (DVD) or a Compact Disc Read Only Memory (CD-ROM) on which the program is recorded. The program may also be distributed by storing the program in a storage of any server and transmitting the program from any server to another computer. The program may be provided as a program product. The present disclosure can also be implemented as a program executable by a processor.

1. A simulator capable of communicating with an energy management system (EMS), the simulator comprising:
a simulator unit configured to execute a simulation of an algorithm program to be evaluated for the EMS;
a performance determination unit configured to determine performance of the algorithm program to be evaluated based on a result of operations of the simulator unit; and
a quality determination unit for the simulation unit,
wherein an interface for when the algorithm program to be evaluated is incorporated into the simulator and an interface for when the algorithm program to be evaluated is incorporated into the EMS are commonalized.

2. The simulator according to claim 1,
wherein the simulator unit includes a reproduction program configured to reproduce an object to be evaluated by the EMS, a simulation program for a device to be controlled by the EMS, and a database for input configured to store input data to be input for executing the simulation, and
the simulator unit is configured to cause the reproduction program and the simulation program to operate using the input data and store an operation result.

3. The simulator according to claim 1, wherein the performance determination unit is configured to determine prediction accuracy or control accuracy of the algorithm program to be evaluated.

4. The simulator according to claim 1, wherein the interfaces that are commonalized include communication standards, programming languages, functions, and/or APIs.

5. The simulator according to claim 1,
wherein the performance determination unit is configured to determine whether the performance of the algorithm program to be evaluated can withstand actual operation, and
the quality determination unit is configured to determine whether the simulator unit has operated correctly.
